(19) United States
(12) Patent Application Publication
(10) Pub. No.: US 2008/0199666 A1
(43) Pub. Date: Aug. 21, 2008

(54) Manufacture of an Impregnated Paper or Non-Woven

(75) Inventor: David Elwyn Price, Williamstown (AU)

Correspondence Address: MERCHANT & GOULD PC, P.O. BOX 2903, MINNEAPOLIS, MN, 55402-0903, US

(73) Assignee: DEPCO-PPG PTY Ltd., Williamstown (AU)

(21) Appl. No.: 11/916,515

(22) PCT Filed: Jun. 6, 2006
(86) PCT No.: PCT/AU2006/000774

§ 371 Date: Dec. 4, 2007

(30) Foreign Application Priority Data
Jun. 6, 2005 (AU) 2005902953

(51) Int. Cl. B41M 5/00; B44C 3/00; B32B 37/00

(52) U.S. Cl. 428/211.1; 427/145; 156/349

(57) ABSTRACT

A method for manufacturing an impregnated paper or non-woven substrate (10) for use as or in a decorative laminate, comprises the steps of: (a) applying a monomer or oligomer to a paper or non-woven substrate (10), in a dry process step (20), which monomer or oligomer forms a film and/or filler bound to the substrate; (b) thereafter applying (30) to the substrate (10) having said film and/or filler of monomer or oligomer; a polymer resin compatible with and cross-linkable with the monomer or oligomer; and (c) treating (40) the resin whereby it forms a cross-link bond with the monomer or oligomer.

### FIELD OF THE INVENTION

The invention relates to the manufacture of an impregnated paper or non-woven material, as well as decorative laminate products manufactured using an impregnated paper or non-woven material according to the invention.

### BACKGROUND TO THE INVENTION

A disadvantage inherent in the current method of manufacturing laminates is the re-introduction of water, as a component of the first impregnating resin, to the paper substrate. In order to produce a paper, an aqueous pulp mass of approximately 98% water is delivered to the wire section at the front of the paper machine, also called the wet end. After formation on the wire the paper is then dewatered, pressed and dried to a controlled moisture content with considerable expenditure of energy. In a following process step of laminate manufacture according to the prior art, the dry paper thus obtained is then remoistened when placing the paper in an aqueous resin bath. The paper, which is manufactured to a requested width, will expand during impregnation with an aqueous resin. The water incorporated in the decor sheet with the resin is removed again in a post impregnation step by energy-consumptive drying and curing to the required b-stage. Thus energy-consumptive drying is required twice in the process of manufacturing laminates from the raw material to the final laminate.

In the current state of the art for the manufacture of decorative laminates, substrates, for example particleboard or fibreboard, are laminated with one or more resin impregnated overlaying papers on one or both sides, in which these paper materials serve as a carrier for the pre-polymer a-stage resin material, pigments and print or any subset of those. These carrier materials also impart an internal stability to the final cured resin through their fibrous structure.

In the manufacture of low pressure melamine (LPM), also known as direct pressure melamine (DPL) and thermo-fused melamine (TFM), the overlaying paper or papers impregnated with resin starting material and partially cured are pressed onto the substrate in a hot press where the resin flows and bonds the carrier material to the substrate and is cured to its final state to form the laminate, called the c-stage laminate.

In the manufacture of high pressure laminates (HPL) several resin impregnated kraft papers are assembled to form the substrate or core material and a resin impregnated decor paper is placed above the kraft papers. In some cases, for instance when a printed decor paper is used, a resin impregnated clear overlay sheet is placed above the decor paper to provide wear protection of the print. Furthermore, in some cases the decorative paper is not impregnated and the clear overlay provides sufficient resin and the high pressure press sufficient pressure to form the uniformly impregnated HPL, this process being known as dry pressing. Hard particles such as fused alumina may be included in or on the clear overlay paper.

In another process known as continuous pressure laminate (CPL) the impregnated decorative paper and impregnated kraft paper or papers, and optionally an impregnated clear overlay paper, are fed from rolls into a double band hot press. The pressure and heating bonds the impregnated papers into a continuous laminate. Alternatively the impregnated papers can be applied directly and simultaneously onto a wood based panel substrate within the continuous press.

Thus in the laminate manufacturing process the resin is partially cured after impregnation of a fibrous material and then substantially fully cured in the hot press. This final curing of the resin conducted in a hot press is where the impregnated papers or non-woven materials are bonded to the substrate surface.

Various innovations have been proposed for visual and mechanical improvements of the laminate surface structure, such as in-register embossing to improve the decorative appearance of the laminates thus manufactured. For these high quality laminates it is particularly important that the embossing, which is incorporated into the surface of the laminate, agrees structurally and topographically with the decor located thereunder. Especially in the case of high-contrast decors, it is important that the mutual alignment of the embossing and the decor layer agree precisely as otherwise the visual impression of a genuine natural product is impaired. The embossing is provided on the surface by use of a suitably embossed negative image on a press plate or continuous press belt, alternatively by other means such as a matrix or embossed sheet.

In the conventional method for manufacturing laminates by the individual steps of laminate manufacture described above it is of importance that the papers to be used as the print base in the process are selected with high precision to have a particularly marked form or stability against distortion. In the manufacture of in-register embossed laminates according to the prior art, the carrier paper for any given print design is nearly always taken from the same paper machine.

When, as is the conventional practice already referred to, a decor paper sheet is immersed in an aqueous resin mixture for impregnation, this paper will tend to expand inconsistently and or non-uniformly and thereby distort any decor print which may be present on its surface. In order to achieve a sufficiently accurate alignment of the printed decor with an embossing and to maintain the visual impression of genuineness, it is thus necessary to know and correlate the expansion characteristics of the paper and the press plate.

To account for the unwanted non-uniform expansion of the printed decor sheet by swelling and the heat-induced expansion of the structured press plates, complex technologies have been developed, which make use of a reverse distorted print that leads to a straightened decor by compensation of the non-uniform expansion of the paper through the corresponding reverse distorted print.

However, this technique of anticipating a non-uniform expansion at the decor print level requires a high precision in the uniformity of the paper for printing, impregnation and subsequent laminate manufacture. Moreover, once the paper expansion characteristics have been determined, it is not feasible to change paper qualities without re-determination of the relative expansion characteristics of the new paper.

It is an object of the invention to at least in part alleviate one or more of these difficulties and complexities of prior art decorative laminate manufacture.

It is another object of the invention to provide a method for manufacturing laminates, which by saving material and energy, is economically more favourable than methods known from the prior art.

### SUMMARY OF THE INVENTION

The invention adopts a concept of reducing remoistening of the paper or non-woven, and thereby also reducing the energy expended on drying, by utilising a dry process for initial resin impregnation of the paper or non-woven

The invention provides a method for manufacturing an impregnated paper or non-woven substrate for use as or in a decorative laminate, comprising the steps of:
(a) applying a monomer or oligomer to a paper or non-woven substrate, in a dry process step, which monomer or oligomer forms a film and/or filler bound to the substrate;
(b) thereafter applying to the substrate having said film and/or filler of monomer or oligomer, a polymer resin compatible with and cross-linkable with the monomer or oligomer; and
(c) treating the resin whereby it forms a cross-link bond with the monomer or oligomer.

The invention further provides apparatus for manufacturing an impregnated paper or non-woven substrate for use as or in a decorative laminate, comprising:
means to apply a monomer or oligomer to a paper or non-woven substrate, in a dry process step, which monomer or oligomer forms a film and/or filler bound to the substrate;
means to thereafter apply to the substrate having said film and/or filler of monomer or oligomer, a polymer resin compatible with and cross-linkable with the monomer or oligomer; and
means to treat the resin whereby it forms a cross-link bond with the monomer or oligomer.

The invention also provides a decorative laminate including or consisting of an impregnated paper or non-woven manufactured by the method of the invention.

Preferably, step (a) is effected by applying a monomer to the paper or non-woven substrate.

Preferably, step (a) is effected by vapour deposition, eg in a vacuum. The vapour deposition advantageously involves sublimation of monomer or oligomer to provide the vapour. Deposition may be facilitated, e.g. by a cold finger cooling the substrate.

Said treatment of the resin may include curing the resin and monomer or oligomer under heat and pressure, e.g. in a hot press.

The monomer is preferably melamine, and the resin is advantageously melamine formaldehyde. The resin may alternatively or additionally be a urea formaldehyde resin, and/or an acrylic resin or any combination of these.

In the method according to a preferred practice of the invention a monomer, for example melamine powder, is applied to the paper or non-woven substrate by means of vapour deposition, and subsequently a crosslinkable coating resin compatible with the monomer, for example melamine formaldehyde or an acrylic resin or a combination of these, is applied to the impregnated paper substrate. After partial curing of the coating resin the employed monomer and polymer are finally cured in a hot press. In the final curing step, the polymer layer forms an inner bond with the monomer and the fibres of the paper or non-woven material.

The monomer impregnated paper can also be employed in a “dry pressing” process, by which is meant that the paper is impregnated according to step (a) of the invention and not further coated before introduction into a press together with said polymer and one or more other components of the laminate. Step (c) is then effected in the press.

By using the method according to the invention, a decorative print on the paper or non-woven substrate remains undistorted through the resin application process because absorption of moisture is avoided. “Undistorted” in the context of the present specification means that any distortion is negligibly small when judged by visual inspection by the human eye. It is thus possible for unwanted non-uniform expansion to be minimized or circumvented, making the process both easier to control and less complex.

The print may be applied to the paper before or after the vapour deposition of the monomer.

The invention thus provides a method for a first impregnation of the paper or non-woven without the use of an aqueous resin, thereby avoiding having to calculate expansion characteristics and calculation of a compensating decor distortion following therefrom.

Another advantage obtained from the method according to the invention is the economical advantage by being able to dispense with re-moistening and subsequent re-drying of carrier materials that are printed with a decor design designated for registered embossing. After vapour impregnation the coating resin may contain water and need to be partially dried, however this will not have an influence on the stability of the paper or print. Therefore implementation of the method results in cost savings when compared to methods in the prior art.

A further advantage of the method according to the invention is a serious reduction in the mass, usually referred to as gsm-grams per square metre, of the paper or non-woven starting material before the application of the monomer, resulting in a lower cost and less heating and curing energy needed for the process.

Melamine as an applicable monomer for the method according to the invention is disclosed in U.S. Pat. Nos. 4,619,735 and 6,632,519, which are incorporated herein as part of the disclosure in this specification.

Water and air are preferably substantially absent when applying the monomer or oligomer in a vacuum chamber, however the melamine monomer is thought to adhere to the fibres of the paper or non-woven by means of hydrogen bonding. This process is facilitated by the aforementioned absence of air, because the resultant voids in the substrate are filled with the gaseous monomer and upon cooling with the solid monomer.

It is known that sublimation of melamine onto a surface leads to extensively hydrogen bonded films. By applying the same principle to fill the core of the paper before applying a compatible coating to both the top and bottom of the paper, and subjecting the composite to heat and pressure, a uniform melamine-rich resin can be achieved. In this way the vapour deposited melamine monomer enriches the melamine content of the resin.

By using melamine as the monomer, the melamine itself provides an opaqueness to the paper, thereby allowing a reduction in the amount of filler required to achieve the desired level of opacity. As a result less material is required to produce given laminates than in the previously known methods and this results in further cost savings.

Based on the economic advantage of using urea formaldehyde resin as an impregnating resin, in an economically advantageous modification of the method according to the invention, urea or other amino derivatives or a combination of these can be used to provide an intermediate layer between the sublimed melamine filling the core and a melamine formaldehyde resin used in the top and reverse sides of the impregnated substrate.

In particular embodiments of the invention, an additional layer or layers of vapour deposited materials may be applied to the impregnated, or impregnated and coated, substrate, to enhance protection of the print or to provide other technical properties. Without being limited by the examples following, such vapour deposited layers could include an oxide layer to improve abrasion resistance, or to provide an anti-static surface, or to provide a non-reflective surface.

In a particular embodiment, the paper or non-woven material is preferably core impregnated with melamine by vapour phase deposition, and in a parallel step the opposite side of the paper is coated with a melamine layer by vapour deposition, wherein the coating remains clear by limiting the thickness of the coating. This thin melamine-rich surface is especially advantageous if the paper or non-woven material has been printed.

It can be advantageous to treat the surface of the impregnated paper or non-woven before applying a further coating. A silane coupling agent is preferred.

The printing of the paper may occur before or after the impregnation by the melamine monomer. For this purpose, the surface to be printed on is advantageously supercalendered to enhance printability.

### BRIEF DESCRIPTION OF THE DRAWINGS

The invention will now be further described, by way of example only, with reference to the accompanying drawings, in which:

FIG. 1 is a diagram of apparatus for manufacturing decorative laminate according to an embodiment of the invention;

FIG. 2 is a fragmentary cross-section of a substrate after application of the melamine monomer; and

FIGS. 3 and 4 are views similar to FIG. 2 of alternative forms of the final laminate.

### PREFERRED EMBODIMENT OF THE APPARATUS

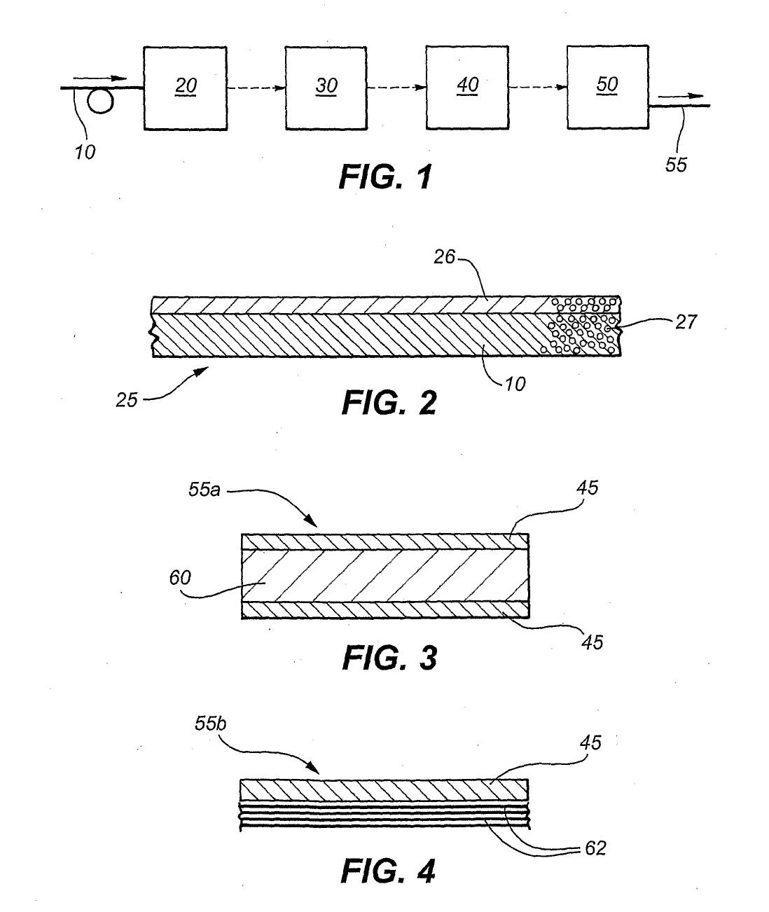

FIG. 1 illustrates exemplary multi-station apparatus for carrying out the method of the invention. The process may be a continuous process through the stations of the apparatus, but is more typically discontinuous in view of the different dwell times and through-put rates of the respective stations. A continuous web of paper or non-woven substrate 10 is placed in a vacuum chamber 20 (FIG. 1). This chamber 20 may be of any suitable proprietary form and is operated conventionally to sublimate a melamine monomer and apply the vapour to substrate 10. Because the chamber 20 is in vacuum, the vapour fills the voids between the fibres of the paper or non-woven.

By cooling the substrate, for example by contacting the substrate with a cold finger in chamber 20, the melamine monomer solidifies to form an intermediate 25 illustrated in FIG. 2, in which the monomer acts as a filler 27 and forms a film 26 bound to the fibres of the paper or non-woven 10 via hydrogen bonding.

The monomer-impregnated intermediate 25 is now passed to a coating station 30, where a suitable compatible polymer resin such as melamine formaldehyde is applied to intermediate 25. The polymer resin is chosen to be cross-linkable with the monomer in a suitable curing step.

The resin may be applied to the impregnated paper by any of a variety of well known methods, not limited to spraying, dipping, brushing, roller or curtain coating. The ideal method is chosen with respect to the properties of the selected resin.

The monomer and polymer-impregnated sheet is now passed through an initial curing station 40 where heat is applied to partially cure the polymer to form a “b-stage” medium. In other cases, curing may utilise radiation or an electron beam, as required for the selected monomer-polymer system.

The b-stage product 45 is conveyed to a hot press 50. Here, the b-stage product is applied to a carrier of either a woodpanel (LPM) or resin impregnated kraft papers (HPL). Heat and pressure are applied to substantially complete curing, in which the melamine formaldehyde resin forms a cross-link bond with the melamine monomer. It is found that with a melamine monomer-polymer system, the optimum polymerisation rate is effected at a press temperature in the range 120° C. to 250° C., more preferably in the range 150° C. to 220° C. In general, on the one hand the coating resin should not polymerise too quickly to avoid subsequent delamination from the monomer-impregnated paper core. On the other hand the speed also should not be too slow, to ensure a minimum throughput of the presses and to avoid the energy consumption of the pressure plates being too high or at least unnecessarily high. The afore-mentioned temperature interval is compatible with the operating temperature range of conventional laminate presses so that existing presses can advantageously be used for the final curing step.

The cooled “c-stage” product 55 of the hot press 50, depicted in two alternate forms 55a, 55b in FIGS. 3 and 4, comprises the original paper or non-woven 10 impregnated with melamine polymer coated with melamine formaldehyde resin combined with a woodpanel 60 known as a low pressure laminate (LPM—FIG. 3) or a number of resin impregnated kraft papers 62 known as a high pressure or continuous pressure laminate (HPL/CPL—FIG. 4). C-stage product 55 can be used in its own right as a decorative laminate or subjected to further processing steps to form a more structured laminate containing product.

The unimpregnated paper 10 may typically have a grammage in the range 10 g/m² to 250 g/m², preferably 15 g/m² to 120 g/m², more preferably 20 g/m² to 80 g/m² most preferably 25 g/m² and 60 g/m². If dyes, pigments or mixtures thereof are added to the substrate, these assist the optical coverage of the substrate in addition to the opaqueness obtained from the melamine powder. In any case the quantity of dyes and pigments required to achieve the desired opacity are reduced by comparison to current state of the art.

1. A method for manufacturing an impregnated paper or non-woven substrate for use as or in a decorative laminate, comprising the steps of:
(a) applying a monomer or oligomer to a paper or non-woven substrate, in a dry process step, which monomer or oligomer forms a film and/or filler bound to the substrate;
(b) thereafter applying to the substrate having said film and/or filler of monomer or oligomer, a polymer resin compatible with and cross-linkable with the monomer or oligomer; and
(c) treating the resin whereby it forms a cross-link bond with the monomer or oligomer.

2. A method according to claim 1 wherein step (a) is effected by applying a monomer to the paper or non-woven substrate.

3. A method according to claim 2 wherein step (a) is effected by vapour deposition.

4. A method according to claim 3 wherein said vapour deposition is effected in a vacuum.

5. A method according to claim 1 wherein step (a) is effected by vapour deposition entailing sublimation of monomer or oligomer to provide the vapour.

6. A method according to claim 5 wherein said substrate contains voids whereby, on said application of the monomer or oligomer by vapour deposition, the voids are partially or completely filled with the monomer or oligomer vapour, and on cooling with the solid monomer or oligomer.

7. A method according to claim 5, wherein said substrate carries printing at its surface, and said monomer or oligomer is applied over said printing by vapour deposition.

8. A method according to any one of claims 3, wherein, said monomer is melamine, and the resin includes or consists of melamine formaldehyde.

9. A method according to any one of claim 8 wherein said resin includes or consists of one or more of a urea formaldehyde resin, and an acrylic resin.

10. A method according to claim 9 wherein the vapour deposited melamine monomer enriches the melamine content of the resin.

11. A method according to any one of claim 1 wherein said treatment of the resin includes curing the resin and monomer or oligomer under heat and pressure.

12. A method according to claim 11 wherein said treatment includes a first, partial curing of the resin, and thereafter a final curing in a hot press with one or more other components that make up the laminate.

13. A method according to claim 11 wherein said treatment comprises introducing the substrate to which the monomer or oligomer has been applied into a press together with said polymer and one or more other components of the laminate, and effecting step (c) in the press.

14. A method according to claim 13, wherein said one or more other components comprise a woodpanel, or kraft papers for HPL.

15. A method according to any one of claim 1, wherein said treated resin further forms a bond with the fibres of the paper or non-woven substrate.

16. A method according to any one of claim 1, wherein the monomer or oligomer applied adheres to the fibres of the paper or non-woven by means of hydrogen bonding.

17. A method according to any one of claim 1, further including providing an intermediate layer that includes urea or other amino derivatives between the sublimed monomer or oligomer in or on the substrate and said polymer resin.

18. A method according to claim 1 further including applying to the impregnated, or impregnated and coated substrate, an additional layer or layers of vapour deposited materials to enhance protection of print or to provide other technical properties.

19. A method according to claim 18 wherein said additional layer comprises an oxide layer.

20. A method according to claim 1, further including after said treatment of the resin, treating the surface of the resin with a coupling agent and then applying thereto a further coating.

21. A method according to claim 1, wherein said treatment of the resin includes curing the resin by heating the resin to a temperature in the range 120° C. and 250° C.

22. A method according to claim 21 wherein said temperature is in the range 150° C. to 220° C.

23. A decorative laminate including or consisting of an impregnated paper or non-woven substrate manufactured by the method of claim 1.

24. A decorative laminate according to claim 23 wherein the applied monomer or oligomer increases the opacity of the paper or non-woven substrate.

25. Apparatus for manufacturing an impregnated paper or non-woven substrate for use as or in a decorative laminate, comprising:
means to apply a monomer or oligomer to a paper or non-woven substrate, in a dry process step, which monomer or oligomer forms a film and/or filler bound to the substrate;
means to thereafter apply to the substrate having said film and/or filler of monomer or oligomer, a polymer resin compatible with and cross-linkable with the monomer or oligomer; and
means to treat the resin whereby it forms a cross-link bond with the monomer or oligomer.

26. Apparatus according to claim 25 wherein said monomer applying means comprises vapour deposition means, arranged whereby said vapour deposition is effected in a vacuum.

27. Apparatus according to claim 26 wherein said resin treating means includes a hot press for effecting curing of the resin and monomer under heat and pressure.

28. Apparatus according to claim 25 wherein said resin treating means includes a hot press for effecting curing of the resin and monomer under heat and pressure.

29. A method according to claim 3 wherein said substrate contains voids whereby, on said application of the monomer or oligomer by vapour deposition, the voids are partially or completely filled with the monomer or oligomer vapour, and on cooling with the solid monomer or oligomer.

30. A method according to claim 3, wherein said substrate carries printing at its surface, and said monomer or oligomer is applied over said printing by vapour deposition.

31. A method according to any claim 1 wherein said resin includes or consists of one or more of a urea formaldehyde resin, and an acrylic resin.

32. A method according to claim 12 wherein said one or more other components comprise a woodpanel, or kraft papers for HPL.

33. A method according to claim 3 wherein said treatment of the resin includes curing the resin and monomer or oligomer under heat and pressure.

34. A decorative laminate including or consisting of an impregnated paper or non-woven substrate manufactured by the method of claim 8.

35. A decorative laminate including or consisting of an impregnated paper or non-woven substrate manufactured by the method of claim 9.

36. A decorative laminate including or consisting of an impregnated paper or non-woven substrate manufactured by the method of claim 10.
